(19) United States
(12) Patent Application Publication
(10) Pub. No.: US 2005/0084580 A1
(43) Pub. Date: Apr. 21, 2005

(54) Convection baking pan system and method

(76) Inventors: Terry G. Jones, Austin, TX (US); Christian Gerard, Austin, TX (US); Philip Leveridge, Austin, TX (US); Louis Lambert, Austin, TX (US); Liz Lambert, Austin, TX (US); Timothy J. Crowley, Marfa, TX (US)

Correspondence Address: H. DALE LANGLEY, JR.;THE LAW FIRM OF H. DALE LANGLEY, JR. PC, 610 WEST LYNN, AUSTIN, TX, 78703, US

(21) Appl. No.: 10/690,164

(22) Filed: Oct. 21, 2003

(51) Int. Cl. A22C 5/00

(52) U.S. Cl. 426/520

(57) ABSTRACT

A system for baking includes a generally concave pan having an upper opening and a generally concave lid engageable with the pan to cover the upper opening. The pan and the lid each have a substantially uniform and thin thickness. If the pan and lid are aluminum, the thickness is on the order of about 1.4 mm to about 2 mm. If the pan and lid are stainless steel, the thickness is about 0.4 mm to about 0.7 mm. When the lid is engaged with the pan, an enclosure is formed that provides fast heat transfer through the enclosure walls and also provides ready internal heat circulation achieving convective heating inside the enclosure. The pan can have a fixed handle, and the top can have a fixed implement groove or attachment. The top engages the pan via locating at least one detent inside the pan outer edge with at least one notch in a rim of the top. The system is re-useable for cooking multiple times. The pan of the system can serve as a serving dish.

### BACKGROUND OF THE INVENTION

The present invention generally relates to baking utensils and, more particularly, relates to convection baking pans and implements and systems and methods therefore.

In certain types of bake cooking, it is desired to fast supply heat to foods in a manner that retains the heat surrounding the foods. An example of this type of cooking has been referred to as “en papillote”. En papillote cooking has conventionally included placing foods to be cooked within a paper or other thin-shell bag or enclosure. Heat is fast transferred through the thin-shell bag, via a conventional oven or the like, and to the food contents of the bag. The thin-shell bag then retains the heat in circulation within the bag for convection baking of the contents.

Other types of cooking also rely on fast heat transfer and convection. Particularly, certain types of foods, and certain desired cooking results for the foods, are preferably prepared and obtained with these and similar fast heat transfer and convection principles. The styles of food preparation involving these types of cooking have included Southwest cuisines, herbed fish and poultry, seasoned vegetables, and similar foods. In these conventional cooking processes, pans have been used for direct flame cooking on a stove top and the like. Heat from the range flame is fast transferred through the bottom of a pan, and the underside of food in the pan is seared with concurrent uni-directional heating throughout the food. This fast heat transfer in cooking is maintained in other styles of cooking, such as grilling, saute, braising, and others.

Although the type of cooking involving fast heat is somewhat conventional, implements, including pans and related cooking utensils for such cooking, have been limited to heavy-walled skillets and the like. In contrast, the paper bags and other make-do and made-up equipment for use in “en papillote” and similar cooking styles provide distinctly different results, because heat transfer into the cooking enclosure is multi-directional and convection heat within the enclosure surrounds the food. Pans and utensils specifically geared to “en papillote” and similar cooking styles have not existed. Moreover, the make-do and made-up utensils and equipment for “en papillote” styles have been solely for one-time use.

It would be a significant improvement in the art to provide pans and similar utensils for performing fast multi-directional heat transfer and convection heating, particularly for use in ovens and like. It would also be an improvement to provide for re-usability of such pans and utensils. Additionally, it would be an improvement to provide more durable and more user-friendly and user-efficient systems and methods for use in such types of cooking. The present invention provides these and numerous other advantages and improvements.

### SUMMARY OF THE INVENTION

An embodiment of the invention is a system for baking. The system includes a thin-walled bottom of thickness ranging from about 0.4 mm to about 2 mm. The system also includes a thin-walled top, for engaging with and enclosing the thin-walled bottom. The thickness of the thin-walled bottom and top effects fast heat transfer internally into the system, and the bottom enclosed with the top effects convective heating internally inside the system.

Another embodiment of the invention is a system for baking including a concave pan having an upper opening. A concave lid is engageable with the pan to cover the upper opening. The pan and the lid each have a substantially uniform thickness selected from: if aluminum, about 1.4 mm to about 2 mm; and if stainless steel, about 0.4 mm to about 0.7 mm

Yet another embodiment of the invention is a fixture for engaging a cooking utensil. The fixture includes a strip with a mediate extension. The mediate extension forms a central slit. At least one pin attaches the strip to a curved surface

Another embodiment of the invention is a method of cooking a food. The method includes enclosing the food in a shell, locating the shell within a multi-directional heat source, multi-directionally directing fast heat transfer into and through the shell, and circulating a heated gas within the shell for convective heat to the food.

Further embodiments of the invention include the product food cooked in the method.

### BRIEF DESCRIPTION OF THE DRAWINGS

The present invention is illustrated by way of example and not limitation in the accompanying figures, in which like references indicate similar elements, and in which:

FIG. 1 illustrates a perspective view of a system for baking with fast heat transfer and convection, according to certain embodiments of the invention;

FIG. 2 illustrates a side view of the system for baking with fast heat transfer and convection, wherein the top is lifted from the bottom of the system, according to certain embodiments of the invention;

FIG. 3 illustrates a side view (looking into the left side of FIG. 1) of an implement fixture fixed to the top of the system of FIG. 1 for opening and closing the top with respect to the bottom, according to certain embodiments of the invention;

FIG. 4 illustrates a top view (looking into the top side of FIG. 1) of the implement fixture of FIG. 3, as fixed to the top of the system of FIG. 1 for opening and closing the top with respect to the bottom, according to certain embodiments of the invention;

FIG. 5 illustrates a perspective, exploded view of the system of FIG. 1, having the top removed from engagement with the bottom, according to certain embodiments of the invention; and

FIG. 6 illustrates a side view of the system of FIG. 1 in operation in an oven, with heat transfer and heat convection generally shown by arrows, according to certain embodiments of the invention.

### DETAILED DESCRIPTION

Referring to FIG. 1, a system 100 for fast heat transfer and convection cooking includes a bottom 102 and a top 104. The bottom 102 is substantially continuously conically curved and convex downward (in FIG. 1) forming an internally concave downward (in FIG. 1) structure. Similarly, the top 104 is substantially continuously conically curved and generally convex upward (in FIG. 1) forming an internally concave upward (in FIG. 1) structure. The top 104 sits and fits atop and within a peripheral upper edge 102a of the bottom 102. The top 104 has a connected implement fixture 106. The bottom 104 has a connected handle fixture 108.

The bottom 102 and top 104 form a cooking vessel, especially suitable for baking. The top 104 is fixed with the bottom 102 when sat and fitted atop the bottom 102 as shown in FIG. 1. The top 104 is sealed with the bottom 102 in a manner creating some, but not excessive, pressure within the system 100 on heating of internals of the system 100. This sealing of the top 104 with the bottom 102 is not to the extent afforded by a pressure cooking vessel, and that is not the intent or purpose of the seal. Nonetheless the top 104 engages with bottom 102 to create some internal pressure within the system 100 and to permit heated vapors within the system 100 to circulate within the system 100 (without ready escape of the vapors) in order to provide for convective heating within the system 100. In certain embodiments, the top 104 can be selectively engaged with the bottom 102 to effect a desired extent of the seal for the system 100. This embodiment is further detailed below, in explanation of the mechanisms in the top 104 and bottom 102 for engaging the top 104 to the bottom 102.

The implement fixture 106 serves to permit an implement (such as a fork, not shown in FIG. 1) to be inserted into a throughway 106a of the fixture 106. This permits the top 104 to be rotatingly (in somewhat of a screw-like manner) engaged and disengaged from the bottom 102 and to be lifted from engagement with the bottom 102. The handle fixture 108 provides a manual catch or grip for a human user to hold and move the bottom 102.

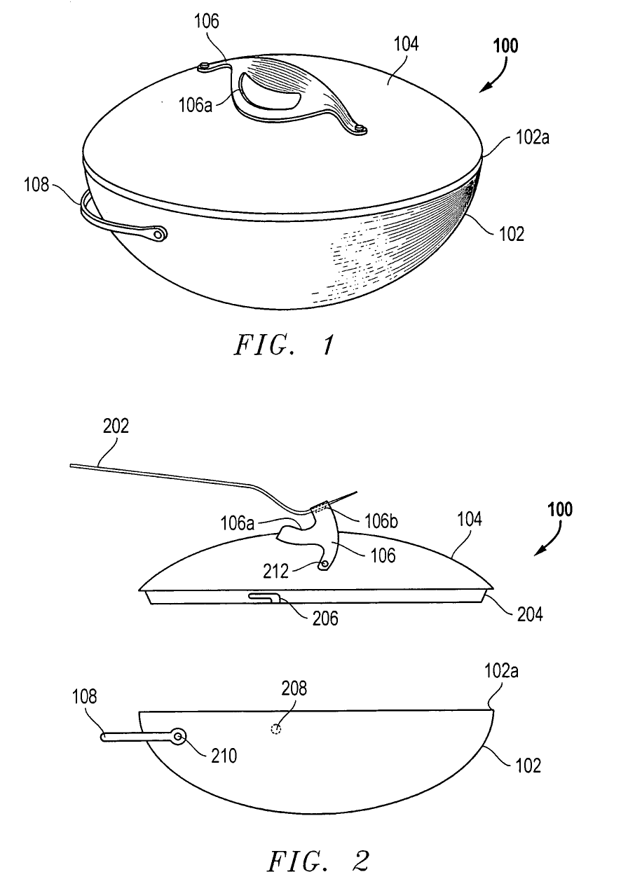

Referring to FIG. 2, the system 100 of FIG. 1 has the top 104 disengaged from atop the bottom 102. The generally and substantially curved and opposingly convex and concave nature of each of the top 104 and the bottom 102 is critical. In FIG. 2, an implement 202 (such as, for example, a fork) is positioned within the throughway 106a of the implement fixture 106. The implement fixture 106 includes a tine feature 106b (shown in phantom) at an underside of the fixture 106 (in the orientation of FIG. 2). The tine feature 106 is mateable between tines of a fork, or the like (not shown), as will be hereinafter detailed. In such position, the implement 202 sufficiently engages with the top 104 to permit the top 104 to be rotated with respect to the bottom 102. The implement 202 also permits the top 104 to be lifted from atop the bottom 102. The implement fixture 106 is fixedly connected to the top 104, for example, by one or more pins 212, such as dual rivets on opposing ends of the fixture 106.

The handle fixture 108 is similarly fixedly connected to the bottom 102, for example, by one or more pins 210, such as dual rivets on opposing ends of the fixture 108. The bottom 102 includes, along an inner periphery thereof just within the bottom 102 from the upper edge 102a, a protruding detent 208. The detent 208 is fixedly connected to the bottom 102. The detent 208 is, for example, a protruding rivet or integrally formed nodule or node internally extending in the bottom 102.

The detent 208 is mateable with a notch 206 of the top 104. The notch 206 of the top 104 is formed in a rim 204 of the top 104. The rim 204 is formed of the top 104 as a peripherally extending lip or portion that is fittable within the upper edge 102a of the bottom 102 and extends inwardly into and in alignment with the bottom 102. The rim 204, when engaged with the bottom 102, permits the top 104 and bottom 102 to fit together as shown in FIG. 1. The detent 208 and the notch 206 are thereby mateable, by rotating the top 104 with respect to the bottom 102 until engaged, so that the top 104 is relatively securely fixed in engagement with the bottom 102. The system 100 can include one or more sets of the detent 208 and notch 206, preferably two generally diametrically opposing sets. Moreover, the notch 206 can extend along a circumferential length of the rim 204, including at an angle thereon, in order to provide a screwing function when the top 104 is rotated to engage the bottom 102.

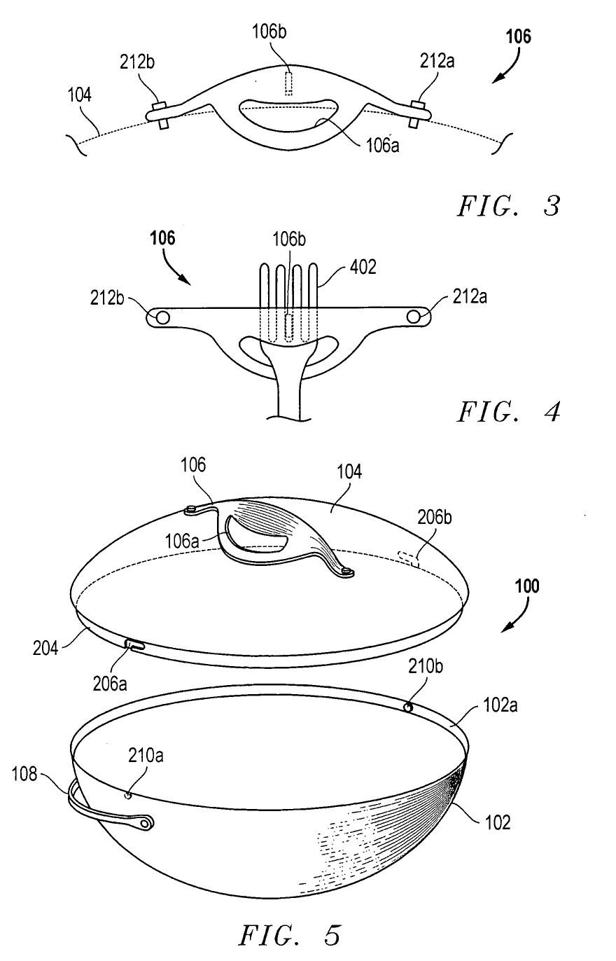

Referring to FIG. 3, the implement fixture 106 extends laterally and attaches to the top 104 (shown in side phantom). The implement fixture 106 includes the throughway 106a in a mediate portion thereof. An underside of the implement fixture 106, in the orientation of FIG. 3, includes the extension of the tine implement 106b. The tine implement 106b is sized to protrude from the underside of the implement fixture 106 and to engage with an implement, such as a fork, by locating within tines of the implement. Each end of the implement fixture 106 is fixed with a respective pin 212a, 212b that connects the fixture 106 to the top 104. The throughway 106a is sufficiently sized to permit an implement, such as a fork, to be lodged therein for twisting and lifting of the top 104. The implement, such as a fork, can pass between tines (or other features) of the implement, the tine fixture 106b of the implement fixture 106. In such manner, the fork or other implement is engaged by the tine fixture 106b with the implement fixture 106 (and, consequently, the top 104), to enable rotating of the top 104 when the fork or other implement is rotated.

Referring to FIG. 4, the implement fixture 106 has an implement, particularly a fork 402 for example purposes, lodged within the throughway 106a. The fork 402 extends partway via the tines, into and through the throughway 106a. Tines of the fork 402 pass on either side of the tine fixture 106b. The fork 402, as so lodged in the throughway 106a with the tine fixture 106b located between tines of the fork 402, is not tightly fitted, but is sufficiently fitted to engage the implement fixture 106 in order to twist the top 104, via movement of the fork 402, with respect to the bottom 102, disengaging respective notch 206 and detent 208, and to lift the top 104 from atop the bottom 102.

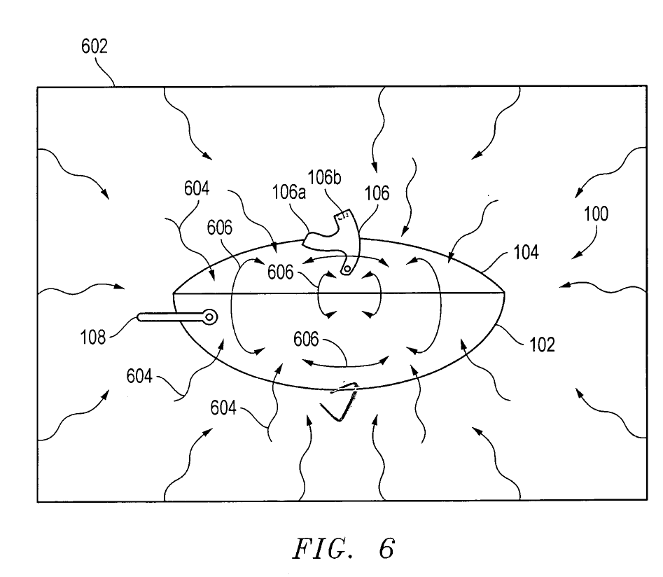

Referring to FIG. 5, the top 104 is shown as displaced by lifting from atop the bottom 102. The bottom 104 includes internally dual detents 210a,b. The detents 210a,b are located substantially diametrically opposed and extending a small distance from the upper edge 102a of the bottom. These detents 210a,b protrude outwardly inside the bottom a short distance, for example, on the order of 1/16 inch or so. The top 104 includes the peripheral rim 204 extending downwardly from the top 104. The rim 204 is formed with upside-down L-shaped notches 206a,b for respectively engaging with the detents 210a,b. The notches 206a,b are, for example, crimped upside-down L-shaped grooves or the like, formed in substantially diametrically opposed portions of the rim 204.

The notches 206a,b encounter the respective detents 210a,b when the top 104 is placed on the bottom 102 and rotated to align the notches 206a,b and detents 210a,b. By further pressing the top 104 onto the bottom 102 when so arranged, the detents 210a,b slide into the respective grooves of the notches 206a,b. The top 104 is then rotated, so that the detents 210a,b proceed within the grooves and this loosely secures the top 104 to the bottom 102.

The notches 206a,b can be angled upwardly towards the respective notch ends thereof, to permit the top 104 to be selectively more tightly engaged with the bottom 102, via the engagement of the detents 210a,b with the notches 206a,b. As the top 104 is rotated to further engage the detents 210a,b with the notches 206a,b along the grooves thereof, the top 104 becomes more securely engaged with the bottom 102. This engagement of the top 104 and bottom 102 provides further effect of sealing of the top 104 to the bottom 102 (including, for example, to limit the extent of escape of heat vapors within the system 100 on heating). In any event, the engagement of the top 104 and bottom 102 does not provide any absolute seal or any extreme pressureability within the system 100. Nonetheless, some internal pressuring of the system 100 is possible, based upon the extent of engagement of the top 104 and bottom 102, as desired and made for the cooking application.

In operation of the system 100, a food to be cooked is placed in the bottom 102. The top 104 is then placed atop the bottom 102. The top 104 is rotated with respect to the bottom 102, in order to align the notches 206a,b of the rim 204 of the top 104 with respective detents 210a,b of the bottom 104. Further rotation of the top 104 with respect to the bottom 102, once the notches 206a,b and detents 210a,b are so aligned, causes the detents 210a,b to proceed along the grooves of the notches 206a,b. This fits the top 104 in select engagement with the bottom 102, as tight as desired for the application (but not absolutely sealed and not sealed to the extent of permitting any extreme pressure buildup within the system 100).

The top 104 is so engaged with the bottom 102, in that vapors and pressure are permitted to remain within the system 100 but to escape from within the enclosed system 100 upon any significant pressurization therewithin. The engagement of top 104 and bottom 102 is not intended and does not serve the particular purpose of pressurizing for pressure cooking and the like. Nonetheless, the engagement fits the top 104 with the bottom 102 in order to maintain and retain the food or other cooking contents of the system 100, and to allow some limited amount of pressure and sealing within the system 100. Moreover, as hereinafter additionally described, the top 104 and bottom 102 engagement of the system 100 provides for fast heat transfer to food contents of the system 100 and also provides for heated gas circulation internally within the system 100 for convection cooking of the food contents.

The top 104 and bottom 102 of the system 100 are each formed of metal, such as an aluminum, stainless steel, iron or other cookware material. In every event, the walls of the system 100 formed of the top 104 and bottom 102 are very thin. Thinness of the top 104 and bottom 102 are critical to providing the cooking features of the system 100. For example, the thickness of the bottom 102 of the system 100 is preferably between about 1.4 mm to about 2 mm if aluminum, and between about 0.4 mm to about 0.7 mm if stainless steel. The top 104 is similarly formed of thin thickness. Although these thicknesses are representative of preferred designs for the system 100, other thicknesses can be appropriate for particular applications, materials or designs; however, in every event, the significance of the thickness is that it must be suitable to permit fast heat transfer and convection cooking.

Moreover, the actual configuration of the bottom 102 and the top 102 are important to enable the desired fast heat transfer and convection effects. Particularly important to the design is the continuous curve nature of each of the respective top 104 and bottom 102. The continuous curve permits and enables the ready circulation of convection heat within the system 100. To further the convection effects, the bottom 104 is formed with conic section as sides, such that the continuous curve from the center of the bottom 102 to the upper edge 102a of the bottom 102 continuously decreases in conic radius of curvature along the increasing distance from center to upper edge 102a. For example, the conical nature of the sides can have on the order of about a mathematical rho value of 0.4 or other similar value and design (e.g., more or less than 0.4 rho or varied or combined rho value). This curvature, and similar curvature alternatives in keeping with the concepts, promotes circulation of hot gas within and throughout the system 100 when in use, without significant differences for circulation within the system 100 (such as traps or areas of concentrated heating).

The fast heat transfer and convection heating by the system 100 when in use serves to quick cook food while moisture remains in the food. In the type of cooking desired and achieved through use of the system 100, heat transfer is instantly obtained throughout (including by virtue of the thinness of the system 100 walls) and the heat is circulated internally throughout (including by virtue of the substantially continuous curved and particular varying conic radius of the system 100 walls).

Referring to FIG. 6, the system 100 in a baking operation, e.g., with food (not shown in detail) enclosed between the bottom 102 and the top 102, is placed within a multi-directional heat source 602. As simply illustrated by arrows 604, heat is transferred multi-directionally from the heat source 602 into and through the bottom 102 and the top 104, for hot and fast heating. The arrows 604 indicate the fast heat transfer, through the bottom 102 and top 104, in such application. This fast heat transfer of the arrows 604, then causes quick heating of gases and other contents contained within the system 100 between the top 104 and bottom 102. As simply illustrated by arrows 606, the gases and contents within the system 100 readily circulate along paths defined by the curvilinear inner surfaces formed by the top 104 and bottom 102. These arrows 606 indicate the convective heating that occurs substantially uniformly throughout the entire enclosure of the system 100. Any food or other contents of the system 100, is, thus, cooked in a fast and thorough manner, by virtue of the fast heat transfer (of arrows 604) and the convective heating (or arrows 606).

In these manners, the system 100 achieves unique cooking effects and unique cooked results. The cooking and results are similar in nature to the “en papillote” types of cooking (but not necessarily identical). Yet, the system 100 is re-usable and durable, and provides other advantages and favorable results in these types and other types of cooking.

Although the system 100 and its use have been described with reference to particular characteristics and advantages in certain uses and ways of use, the system 100 is suitable for numerous other uses and types of cooking. Alternatively, for example, the system 100 can be used with a more unidirectional heat source, such as a range top or direct flame, or with direct and/or indirect heat sourcing applied to the system 100. Moreover, the system 100 can be used as a serving tray by removing the top 104 and retrieving cooked contents directly from the bottom 102. A wide variety of other alternatives for use of, and for enhancement or substitution in, the system 100 are also possible, and will be appreciated and understood.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A system for baking, comprising:
a thin-walled bottom of thickness ranging from about 0.4 mm to about 2 mm;
a thin-walled top, for engaging with and enclosing the thin-walled bottom;
wherein the thicknesses of the thin-walled bottom and the thin-walled top effect fast heat transfer internally into the system and the thin-walled bottom combined with the thin-walled top effects convective heating internally inside the system.

2. The system of claim 1, wherein:
the thin-walled bottom includes a substantially curvilinear shell; and
the thin-walled top also includes a substantially curvilinear shell.

3. The system of claim 1, further comprising:
an implement fixture attached to the top, useable for removing the top from the bottom and engaging the top with the bottom.

4. The system of claim 1, further comprising:
a handle attached to the bottom, useable for handling the bottom.

5. The system of claim 1, further comprising:
at least one detent of the bottom; and
at least one notch of the top;
wherein the detent is engageable with the notch to locate the top to the bottom.

6. A system for cooking, comprising:
a concave pan having an upper opening;
a concave lid engageable with the pan to cover the upper opening;
wherein the pan and the lid each have a substantially uniform thickness selected from the group consisting of: if aluminum, about 1.4 mm to about 2 mm; and if stainless steel, about 0.4 mm to about 0.7 mm.

7. The system for cooking of claim 6, further comprising:
A convex inside of the pan enterable via the upper opening; and
A convex inside of the lid;
wherein the pan and the lid are engageable to form an internally curvilinear surfaced enclosure.

8. The system for cooking of claim 7, wherein respective relatively uniform thicknesses of the pan and the top effect fast heat transfer internally to the internally curvilinear surfaced enclosure and the top engaged with the pan effects convective heating internally within the internally curvilinear surfaced enclosure.

9. The system of claim 8, further comprising:
an implement fixture fixed to the lid, having an tine fixture.

10. The system of claim 9, further comprising:
a handle fixed to the pan.

11. A fixture for engaging a cooking utensil, comprising:
a strip with a mediate extension, wherein the extension is formed with a central slit;
a tine rib on the strip; and
at least one pin for attaching the strip to a curved surface.

12. The fixture of claim 11, wherein the strip is curved to extend above the curved surface when attached thereto.

13. The fixture of claim 12, wherein the central slit of the mediate extension is sized to accept therethrough the cooking utensil in an engaging manner with the tine rib, to permit movement of the strip by handling and moving the cooking utensil.

14. A method of cooking a food, comprising the steps of:
enclosing the food in a shell;
locating the shell directly in a multi-directional heat source;
directing multi-directional fast heat transfer into and through the shell, via the multi-directional heat source; and
circulating a heated gas within the shell for convective heat to the food.

15. The method of claim 14, further comprising the steps of:
supplying a curvilinear pan of thin thickness;
placing the food in the curvilinear pan; and
engaging a curvilinear top of thin thickness atop the pan to form an enclosure.

16. The method of claim 14, further comprising the steps of:
re-using the shell for cooking.

17. The method of claim 15, further comprising the step of:
re-using the pan and the top for cooking.

18. The method of claim 14, further comprising the step of:
serving the food inside the shell.

19. The method of claim 15, further comprising the step of:
serving the food inside the pan.

20. The product cooked food of the method of claim 14.

21. The product cooked food of the method of claim 15.
